(19) United States
(12) Patent Application Publication
(10) Pub. No.: US 2008/0102669 A1
(43) Pub. Date: May 1, 2008

(54) Card connector capable of preventing electronic card from disengagement therefrom

(75) Inventor: Yaw-Huey Lai, Taipei county (TW)

Correspondence Address: BACON & THOMAS, PLLC, 625 SLATERS LANE, FOURTH FLOOR, ALEXANDRIA, VA, 22314, US

(73) Assignee: TAI-SOL ELECTRONICS CO., LTD., Taipei City (TW)

(21) Appl. No.: 11/656,415

(22) Filed: Jan. 23, 2007

(30) Foreign Application Priority Data
Oct. 25, 2006 (TW) 95218892

(51) Int. Cl. H01R 13/62

(52) U.S. Cl. 439/159

(57) ABSTRACT

A card connector includes a housing having a base plate, a stationary terminal area located at a first side of the base plate, a slide way located at a second side of the base plate, and a hollow portion formed at a front end of the slide way; a slide member slidably mounted at a second side of the stationary terminal area; and an anti-run member having a main body and a buckle piece extending and protruding upward from a front end of the main body. When the slide member is moved to a rear end of the slide way, the buckle piece engages a concavity located at one side of the card. Because the buckle piece is supported by the slide way and have a larger part engaged in the concavity of the card, even if the card connector is violently shocked or wobbled, the buckle piece will not disengage from the concavity of the card.

### BACKGROUND OF THE INVENTION

1. Field of the Invention

The present invention relates generally to electronic card connectors, and more particularly, to a card connector capable of effectively preventing an inserted card from disengagement therefrom.

2. Description of the Related Art

A conventional card connector, as shown in FIG. 11 and disclosed in Taiwan Patent Publication No. 568,424, includes a base 2, a slide way 23 formed at the right side of the base 2, a recession 231 formed at a midsection of the slide way 23, a lock-up means longitudinally slidably mounted above the slide way 23, and a buckle piece 34 mounted at a bottom side of the lock-up means and having a convexity 341 formed at a front end thereof. When an electronic card 8 having a concavity 82 formed at one side thereof and a side portion 81 formed at a front corner thereof is initially inserted into the card connector, the card 8 squeezes the convexity 341 to enable the convexity 341 to downward engage the recession 231 and to enable the card 8 to pass over the convexity 341. When the side portion 81 contacts against the push portion 33, the convexity 341 enters the concavity 82. When the card 8 continues to enter, the card 8 contacts against the lock-up means and pushes it to move backward and then the lock-up means drives the buckle piece 34 to move backward; meanwhile, the convexity 341 disengages from the recession 231 and then climbs the slide way 23 and the convexity 341 still engages the concavity 82. Because the slide way 23 supports the convexity 341, the convexity 241 is not subject to disengagement from the concavity 82, thus tightly fastening the card 8.

However, when the card 8 squeezes the convexity 341, the resilience of the convexity 341 is affected very much and the convexity 341 limitedly engages the concavity 82. Thus, the convexity 341 easily disengages from the concavity 82, when the card connector is violently shocked or wobbled by human hands, thus failing to effectively prevent the card from disengagement from the card connector.

### SUMMARY OF THE INVENTION

The primary objective of the present invention is to provide a card connector which can effectively prevent an inserted card from accidental disengagement therefrom.

The foregoing objective of the present invention is attained by the card connector composed of a housing, a slide member, and an anti-run member. The housing includes a base having a base plate, a stationary terminal area located at a first side of the base plate for mounting conductive terminals, and a slide way formed at a second side of the base plate for supporting the anti-run member. The slide member is slidably mounted at a second side of the stationary terminal and lies on the slide way for slidable movement along the direction the card is inserted. The anti-run member is mounted to a front end of the slide member, including a main body extending forward from the front end of the slide member, and a buckle piece extending and protruding upward from a front end of the main body. A hollow portion is formed at a front end of the slide way. When the slide member is moved to a rear end of the slide way, the buckle piece engages a concavity located at one side of the card. The buckle piece at a part thereof close to the second side is located on the slide way to be supported by the slide way.

In light of the above, the present invention includes the following effects. When the card pushes the slide member to move backward, the buckle piece is moved to a surface of the slide way. Because the buckle piece is supported by the slide way and protrudes upward from the main body to have a larger part extending into the concavity of the card, even if the card connector is violently shocked or wobbled by the human hand, the buckle piece will not disengage from the concavity of the card and keep securely engaging the concavity of the card, effectively preventing the card from backing and disengagement from the card connector.

### BRIEF DESCRIPTION OF THE DRAWINGS

FIG. 1 is an exploded view of a preferred embodiment of the present invention.

FIG. 2 is a perspective view of the preferred embodiment of the present invention which housing is separated therefrom.

FIG. 3 is a perspective view of the preferred embodiment of the present invention which housing is removed, illustrating a card is initially inserted therein.

FIG. 4(A) is a top view of FIG. 3.

FIG. 4(B) is a sectional view taken along a line 4-4 indicated in FIG. 4(A).

FIG. 5 is another perspective view of the preferred embodiment of the present invention in action, illustrating the buckle piece is squeezed by the card and has not engaged the concavity of the card.

FIG. 6(A) is a top view of FIG. 5.

FIG. 6(B) is a sectional view taken along a line 6-6 indicated in FIG. 6(A).

FIG. 7 is FIG. 3, illustrating the moment that the buckle piece engages the concavity of the card.

FIG. 8(A) is a top view of FIG. 7.

FIG. 8(B) is a sectional view taken along a line 8-8 indicated in FIG. 8(A).

FIG. 9 is similar to FIG. 3, illustrating the card is fully inserted into the card connector.

FIG. 10(A) is a top view of FIG. 9.

FIG. 10(B) is a sectional view taken along a line 10-10 indicated in FIG. 10(A).

FIG. 11 is a perspective view of the conventional card connector.

### DETAILED DESCRIPTION OF PREFERRED EMBODIMENTS

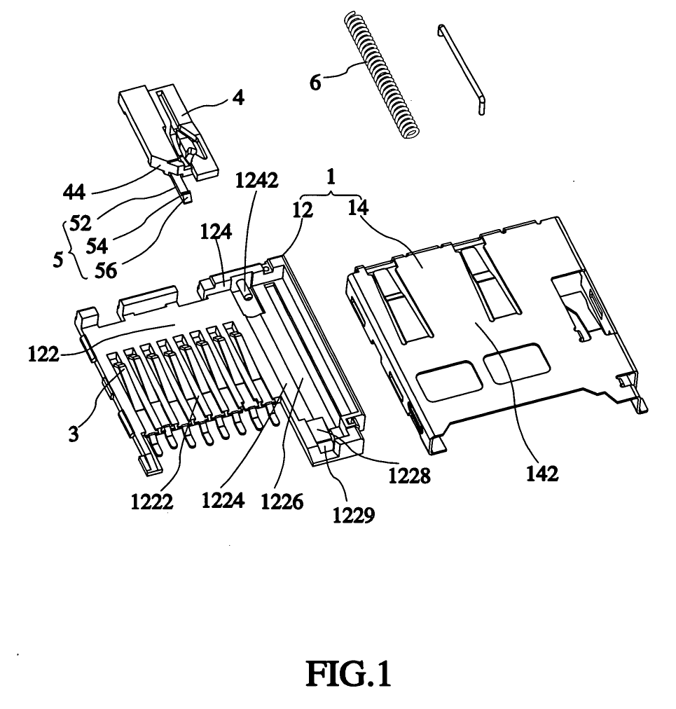

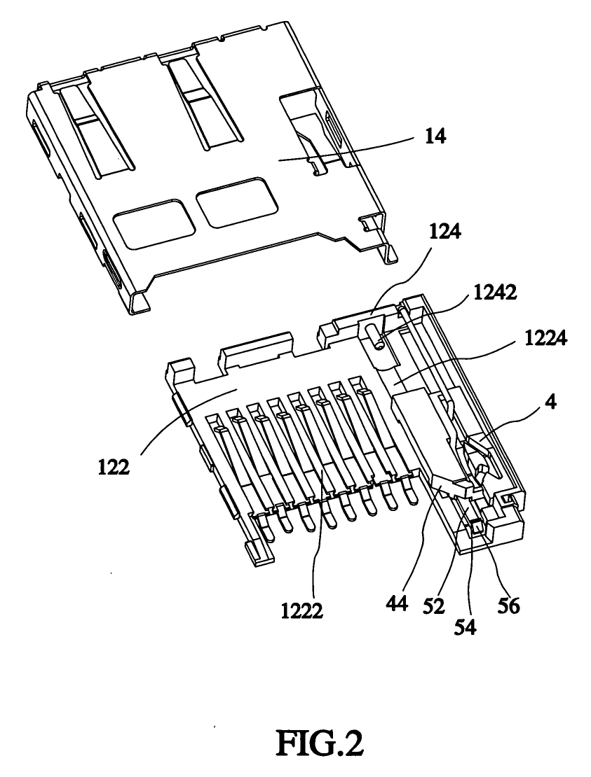

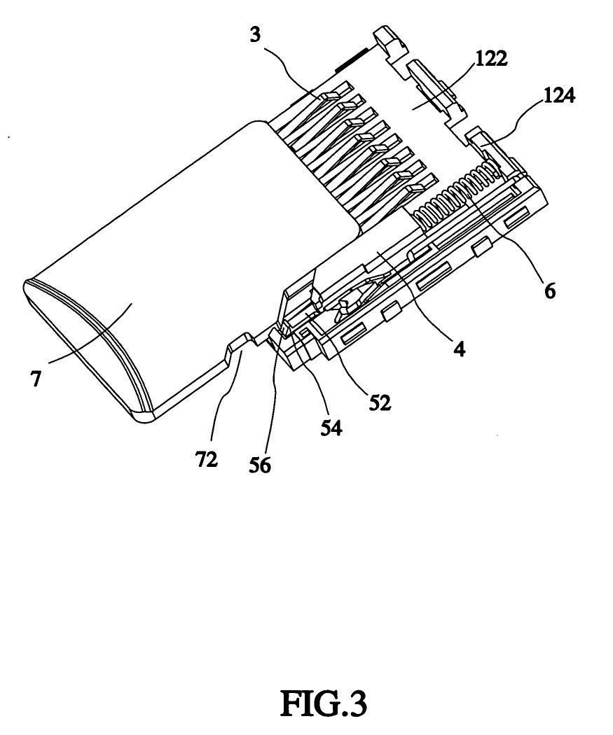

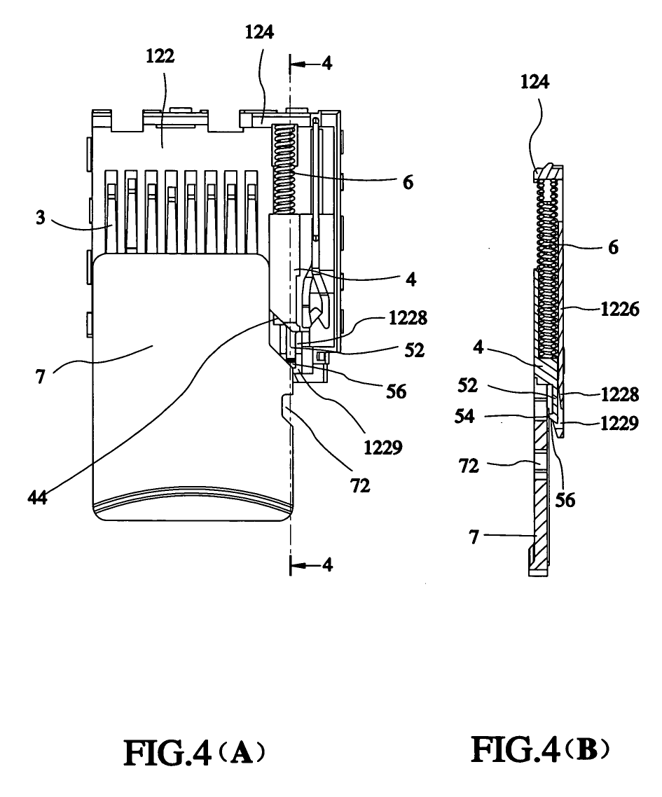

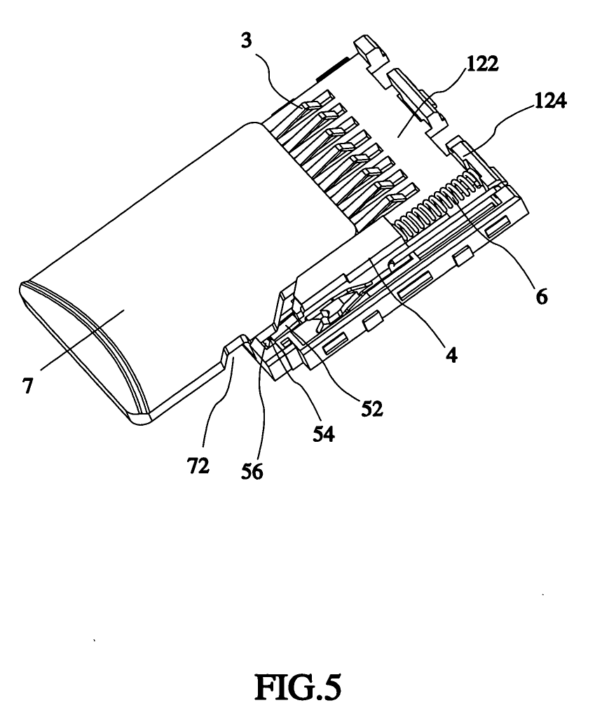

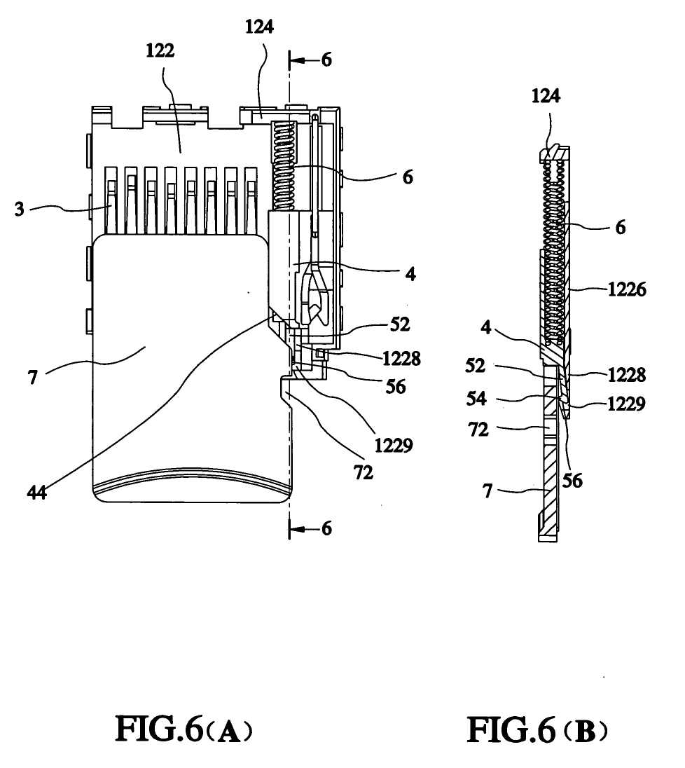

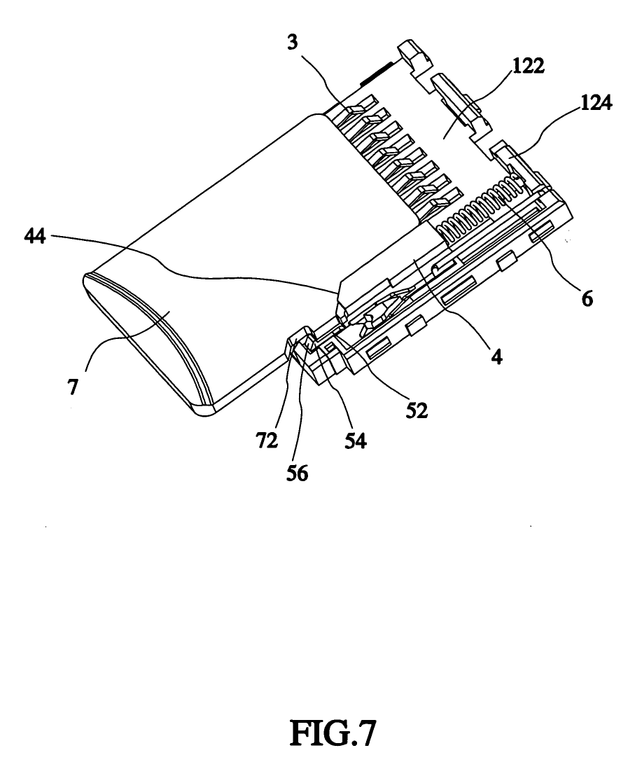

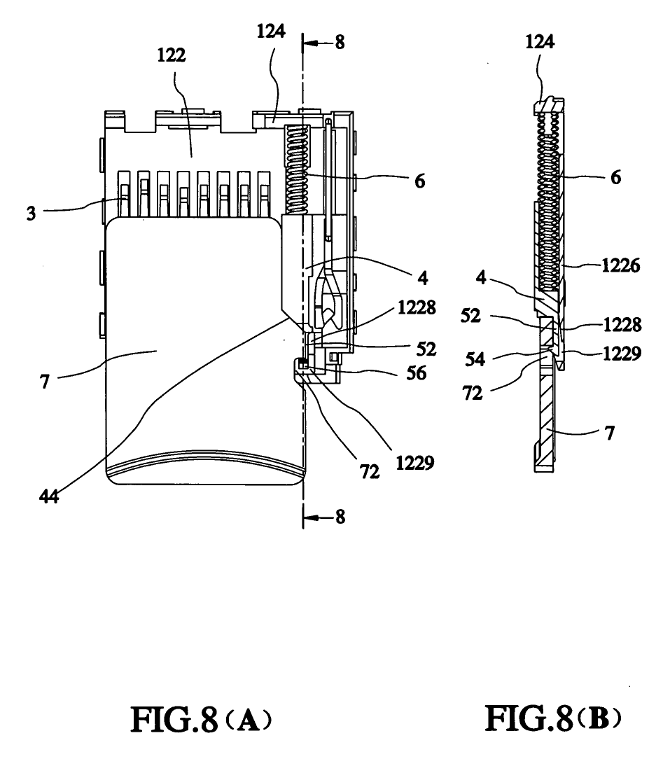

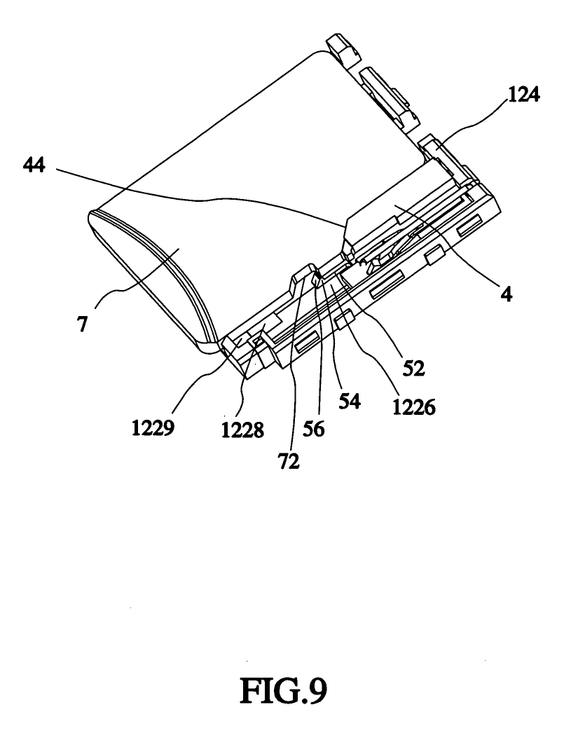

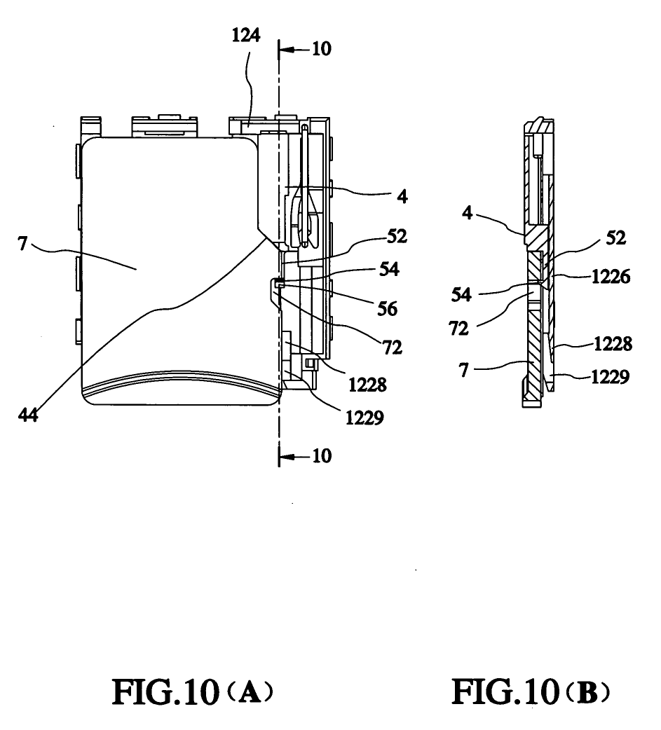

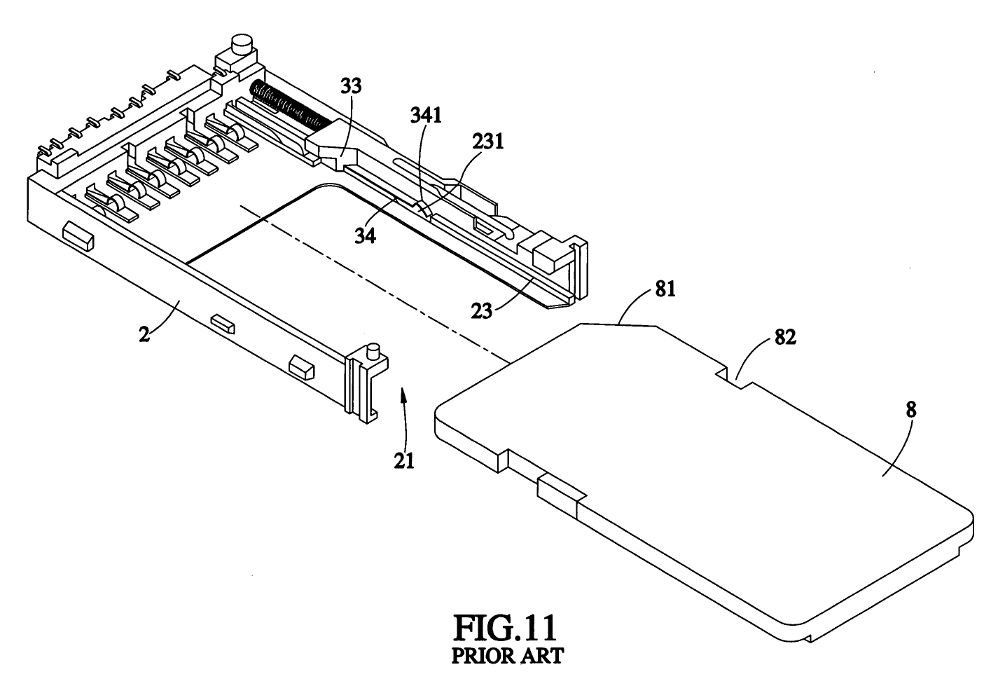

Referring to FIGS. 1-10, a card connector capable of preventing an electronic card from accidental disengagement therefrom, constructed according to a preferred embodiment of the present invention, is composed of a housing 1, a group of conductive terminals 3, a slide member 4, an anti-run member 5, and a spring 6.

The housing 1 includes a base 12 and a cover member 14.

The base 12 includes a base plate 122 and a rear plate 124 extending vertically upward from a rear end edge of the base plate 122. An electronic card 7 having a concavity 72 formed at one side thereof can be inserted into the card connector from a front end of the base plate 122. The base plate 122 has a stationary terminal area 1222 formed at a first side thereof for mounting the conductive terminals 3, a groove 1224 formed at a second side thereof and located close to the stationary terminal area 1222 and extending along a direction that the card 7 is inserted, and an elongated slide way 1226 formed at a second side of the groove 1224 and extending along the direction that the card 7 is inserted for supporting the anti-run member 5. The slide way 1226 is located as high as the base plate 122. An inclined guide portion 1228 is formed at respective front ends of the groove 1224 and the slide way 1226. The guide portion 1228 at a rear end thereof located close to a first side thereof is connected with the front end of the groove 1224. The guide portion 1228 at the rear end thereof located close to a second side thereof is connected with the front end of the slide way 1226. A hollow portion 1229 is formed at a front end of the guide portion 1228. A projecting bar 1242 is formed on the rear plate 124, corresponding to the groove 1224 and protruding forward.

The cover member 14 is buckled onto the base 12, including a top plate 142. The card 7 is located between the base plate 122 and the top plate 142 while inserted.

The conductive terminals 3 are mounted to the stationary terminal area 1222.

The slide member 4 is slidably mounted to a second side of the stationary terminal area 1222, lying on the groove 1224 and the slide way 1226, for slidable movement along the direction that the card 7 is inserted. The slide member 4 includes a push portion 44 extending toward a first side thereof from a top side thereof.

The anti-run member 5 is connected with the slide member 4 in one piece and located in front of the slide member 4. The anti-run member 5 includes a main body 52 extending forward from the front end of the slide member 4, and a buckle piece thereof 54 extending and protruding upward from a front end of the main body 52. The buckle piece 54 has an inclined guide portion 56 formed at a front end thereof. Before the card 7 is inserted into the card connector, the buckle piece 54 is located above the hollow portion 1229. When the card 7 is fully inserted into the card connector, the buckle piece 54 at a part thereof located close to a first side thereof is located above the groove 1224 and engages the concavity 72 of the card 7; the buckle piece 54 at a part thereof located close to a second side thereof lies on the slide way 1226.

The spring 6 includes two ends inserted onto the projecting bar 1242 of the rear plate 124 and onto a part of the slide member 4 corresponding to the front end of the slide member 4 respectively.

When assembling the card connector of the present invention, first mount the slide member 4 in the base 12, enabling the buckle piece 54 to be located above the hollow portion 1229 and enabling the main body 52 to be located on the slide way 1226; mount the spring 6 to between the rear plate 124 and the slide member 4 and then mount the cover member 14 onto the base 12.

While the card 7 is initially inserted into the card connector, the card 7 squeezes the buckle piece 54 of the anti-run member 5 to move downward and then the buckle piece 54 enters the hollow portion 1229 to enable the card 7 to pass over the buckle piece 54 and continue to be inserted further. The guide portion 56 of the buckle piece 54 facilitates the card 7 to pass through the buckle piece 54. While the card 7 at a front end thereof contacts the push portion 44 of the slide member 4, the buckle piece 54 is no longer squeezed by the card 7 to engage the concavity 72 of the card 7. While the card 7 continues to enter further, its front end pushes the push portion 44 to further push the slide member 4 to move toward the rear plate 124 and then the anti-run member 5 is moved together with the rear plate 124. In the meantime, the buckle piece 54 climbs the slide way 1226, the buckle piece 54 at a second side thereof lies on the slide way 1226 and be supported by the slide way 1226, and thus the buckle piece 54 keeps engaged in the concavity 72.

When the card connector is violently shocked and wobbled by the human hand, because the buckle piece 54 lies on the slide way 1226 and the slide way 1226 upwardly supports the buckle piece 54, the buckle portion 54 impossibly disengages from the concavity 72 and keeps securely engaging the concavity 72, thus preventing the card 7 from backing and disengagement from the card connector.

The present invention includes the following effects. When the card 7 pushes the slide member 4 to move backward, the buckle piece 54 climbs the slide way 1226. Because the slide way 1226 supports the buckle piece 56, the buckle piece 54 protrudes upward from the main body 52, and the buckle piece 54 has a larger part engaged in the concavity 72, even if the card connector is violently shocked or wobbled, the buckle piece 54 will impossibly disengage from the concavity 72 of the card 7 and still securely engage the concavity 72 to effectively prevent the card 7 from backing and disengagement from the card connector.

It is to be noted that the above-mentioned first and second sides are the left and right sides respectively in this embodiment. The first side can alternatively be the right side and the second side can alternatively be the left side, which are the equivalent interchange of the present invention and fall in the scope of the appended claim.

In the aforementioned embodiment, the guide portion 1228 at the rear end located close to the first side thereof is connected with the front end of the groove 1224. The guide portion 1228 at the rear end located close to the second side thereof is connected with the front end of the slide way 1226. The hollow portion 1229 is located at the front end of the guide portion 1228 and the guide portion 1228 is wider. In this regard, the guide portion can be alternatively formed at the front end of the slide way with the same width as the above-mentioned embodiment; likewise, the guide portion has a hollow portion formed at the front end thereof, and the anti-run member and other components are consistent with those of the first embodiment in structure and location of assembly. The buckle piece 54 engages the concavity 72 of the card 7. The buckle piece 54 at the second side thereof lies on the slide way 1226 and be supported by the slide way 1226, such that the buckle piece 56 will not disengage from the concavity of the card even if the card connector is violently shocked or wobbled, effectively preventing the card from backing and disengagement from the card connector.

Although the present invention has been described with respect to a specific preferred embodiment thereof, it is no way limited to the details of the illustrated structures but changes and modifications may be made within the scope of the appended claims.

What is claimed is:

1. A card connector capable of preventing a card from disengagement therefrom, said card having concavity formed at one side thereof, said card connector comprising a housing, a slide member, and an anti-run member, wherein
said housing having a base, said base having a base plate, a stationary terminal area formed at a first side of said base plate for mounting conductive terminals, a slide way formed at a second side of said base plate for supporting said anti-run member, and a hollow portion formed at a front end of said slide way;
said slide member slidably mounted at a second side of said stationary terminal area and lying on said slide way for slidable movement along a direction that the card is inserted into said card connector; and
said anti-run member mounted in front of said slide member and having a main body and a buckle piece, said main body extending forward from a front end of said slide member, said buckle piece extending and protruding upward from a front end of said main body;
whereby when said slide member is moved to a rear end of said slide way, said buckle piece engages said concavity of the card and said buckle piece having a part close to a second side thereof is located on said slide way to be supported by said slide way.

2. The card connector as defined in claim 1, wherein the first side is the left side and the second side is the right side.

3. The card connector as defined in claim 1, wherein the first side is the right side and the second side is the left side.

4. The card connector as defined in claim 1 or 2 or 3, wherein said anti-run member is connected with the front end of the slide member in one piece.

5. The card connector as defined in claim 1 or 2 or 3, wherein said housing further comprises an inclined guide portion located between said slide way and said hollow portion.

6. The card connector as defined in claim 4, wherein said housing further comprises an inclined guide portion located between said slide way and said hollow portion.

7. The card connector as defined in claim 6, wherein said base further comprises a groove located at a second side thereof and abutting said stationary terminal area; said slide way is formed at a second side of said groove; said guide portion is located at respective frond ends of said groove and said slide way; said hollow portion is located at a front end of said guide portion, said guide portion at a rear end thereof located close to a first side thereof being connected with the front end of said groove, said guide portion at the rear end thereof located close to a second side thereof being connected with the front end of said slide way.

8. The card connector as defined in claim 1 or 2 or 3, wherein said buckle piece further comprises an inclined guide portion formed at a front end thereof.

9. The card connector as defined in claim 4, wherein said buckle piece further comprises an inclined guide portion formed at a front end thereof.

10. The card connector as defined in claim 6, wherein said buckle piece further comprises an inclined guide portion formed at a front end thereof.
